(19) United States
(12) Patent Application Publication
(10) Pub. No.: US 2004/0093304 A1
(43) Pub. Date: May 13, 2004

(54) System and method for automatically notifying payment

(76) Inventors: Chung-I Lee, Tu-Chen (TW); Floye Lin, Shenzhen (CN); David Fan, Shenzhen (CN); Xuechun Lin, Shenzhen (CN); Deyi Xu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,426

(22) Filed: Dec. 30, 2002

(30) Foreign Application Priority Data
Nov. 13, 2002 (TW) 91133217

(51) Int. Cl. G06F 17/60

(52) U.S. Cl. 705/40

(57) ABSTRACT

A system for automatically notifying payment includes a database server (1), an application server (2), a network (3), and a plurality of client computers (4) located in various different places. The database server stores customer information and corresponding payment information. The application server generates payment notifications according to the customer information and corresponding payment information stored in the database server. The application server can select suitable languages and set appropriate times for transmission of the payment notifications, according to the customers' particular working circumstances. The payment notifications are automatically duplicated and encrypted before sending to the relevant customers. The application server sends the payment notifications to respective customers at the client computers. A related method is also disclosed.

### BACKGROUND OF THE INVENTION

1. Field of the Invention

The present invention relates to systems and methods for automatically notifying payment, and particularly to such a system and method which can select languages and means of transmission suitable for the particular working circumstances of various customers.

2. Background of The Invention

With the popular usage of information transmission technology, it is now commonplace for enterprises to integrate information using business management systems. In the field of providing payment notifications, both full use of resources and reasonable time arrangements are desired. However, conventional business management systems and methods have certain shortcomings.

A conventional method for automatically notifying payment is disclosed in China Patent CN1347051, issued on May 1, 2002 and entitled “Charging Method of Internet Consumption.” However, this method cannot satisfactorily provide customers with automatic payment reminders. This is because it does not adequately address languages used by the customers, nor transmission means most suitable for the customers' respective working circumstances.

A system and method for automatically notifying payment which overcomes the above-mentioned shortcomings is desired.

### SUMMARY OF THE INVENTION

An object of the present invention is to provide a system for notifying payment which automatically calculates a fee payable, generates payment notification, selects a suitable language for the notification, and selects a suitable means for transmitting the notification.

Another object of the present invention is to provide a method for notifying payment which automatically calculates a fee payable, generates payment notification, selects a suitable language for notification, and selects a suitable means for transmitting the notification.

To achieve the above objects, the present invention provides a system and method for automatically notifying payment. An application server automatically calculates an account receivable according to preset formulas and customer information stored in a database server, automatically generates a payment notification and duplicates the payment notification in the database server, selects an appropriate language and format of the payment notification and automatically encrypts it, connects with the database server to search for the customer's IP (Internet protocol) address, selects a suitable transmission means, and transmits the payment notification to the customer at a designated time that is during the customer's business hours. Thereby, an integrated payment notification procedure is established, to enhance system efficiency and provide customer-friendly service. The system and method for automatically notifying payment uses a three-layer architecture; that is, a database server, an application server, and a plurality of client computers. This provides centralized information storage and distributed system application. Via the application server, the client computers can obtain payment notifications automatically generated according to preset formulas and customer information. An authorized user can pre-set for each customer a suitable language and format of the payment notification, and pre-set a transmission time for the payment notification.

A preferred embodiment of the system for automatically notifying payment comprises: a database server, which is used to store information on customers; an application server, which is used to automatically generate and send payment notifications to customers to remind customers to pay in time according to the customers' particular working circumstances; and a plurality of client computers, which are located in various different places to receive payment notifications sent by the application server.

A preferred embodiment of the method for automatically notifying payment comprises the following steps: (a) the application server automatically calculating an account receivable according to preset formulas and customer information stored in the database server; (b) the application server automatically generating a payment notification, and storing a copy of the payment notification in a customer information table of the database server; (c) the application server automatically selecting a suitable language, and encrypting the information in the payment notification; (d) the application server connecting with the database server, and searching for a customer's IP address; (e) the application server selecting a suitable transmission means to send the payment notification; (f) the application server selecting the customer's office hours to send the payment notification, and sending the payment notification accordingly; and (g) the application server receiving the customer's confirmatory feedback information; otherwise, the application server returning to step (f) to re-send the payment notification, and proceeding accordingly until the application server receives the customer's confirmatory feedback information.

Other objects, advantages and novel features of the present invention will be drawn from the following detailed description of preferred embodiments of the present invention with the attached drawings, in which:

### BRIEF DESCRIPTION OF THE DRAWINGS

FIG. 1 shows hardware infrastructure of a system for automatically notifying payment in accordance with a preferred embodiment of the present invention;

FIG. 2 is a block diagram of function modules of an application server of the system of FIG. 1;

FIG. 3 illustrates an exemplary customer information table according to the present invention; and

FIG. 4 is a flow chart of a preferred method for generating a payment notification and automatically notifying payment, in accordance with the present invention.

### DETAILED DESCRIPTION OF THE INVENTION

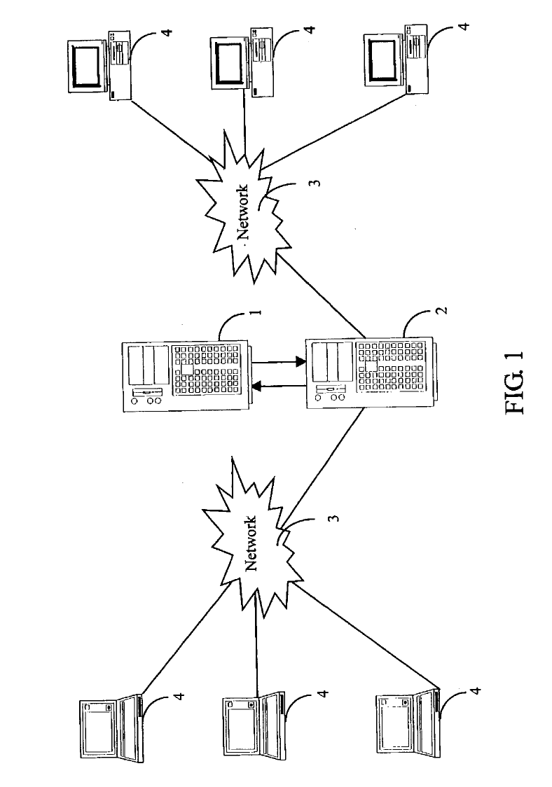

FIG. 1 shows hardware infrastructure of a system for automatically notifying payment in accordance with a preferred embodiment of the present invention. The system comprises a database server 1, an application server 2, and a plurality of client computers 4 connected to the application server 2 via a network 3. In the preferred embodiment of the present invention, the network 3 is the Internet 3. The database server 1 manages reading, writing and maintenance of information in a database located therein, executes updating and searching of information, and stores information on customers. The application server 2 comprises central and changeable information, and includes programming, operation means, management modules and so on. The application server 2 receives input information, processes the information, and returns results. The results are used to generate and send payment notifications to remind customers to pay in time according to the customers' particular working circumstances. The client computers 4 are located in various different places, and receive payment notifications sent by the application server 2.

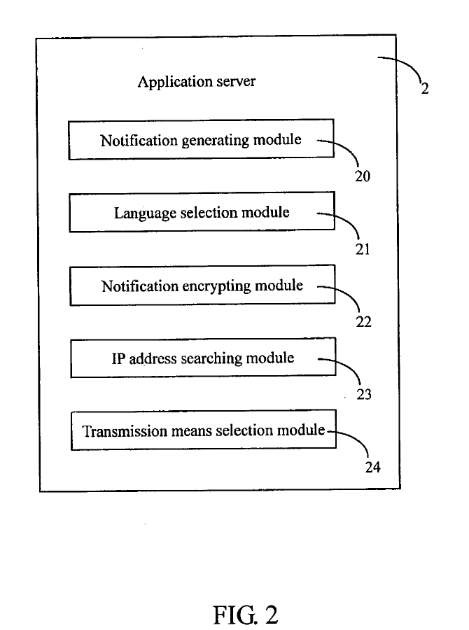

FIG. 2 is a block diagram of function modules of the application server 2. The application server 2 comprises a notification generating module 20, a language selection module 21, a notification encrypting module 22, an IP (Internet protocol) address searching module 23, and a transmission means selection module 24. The notification generating module 20 automatically calculates an account receivable for a customer's matter according to preset formulas and customer information stored in the database server 1, and generates a payment notification. The language selection module 21 automatically selects a suitable language for the customer, and translates the payment notification accordingly. The notification encrypting module 22 automatically encrypts the payment notification to ensure its secure transmission. The IP address searching module 23 connects with the database server 1 to search for the IP address of the customer, and confirms that the searched IP address is the same as that of the payment notification. The transmission means selection module 24 automatically selects suitable transmission means for transmission of the payment notification.

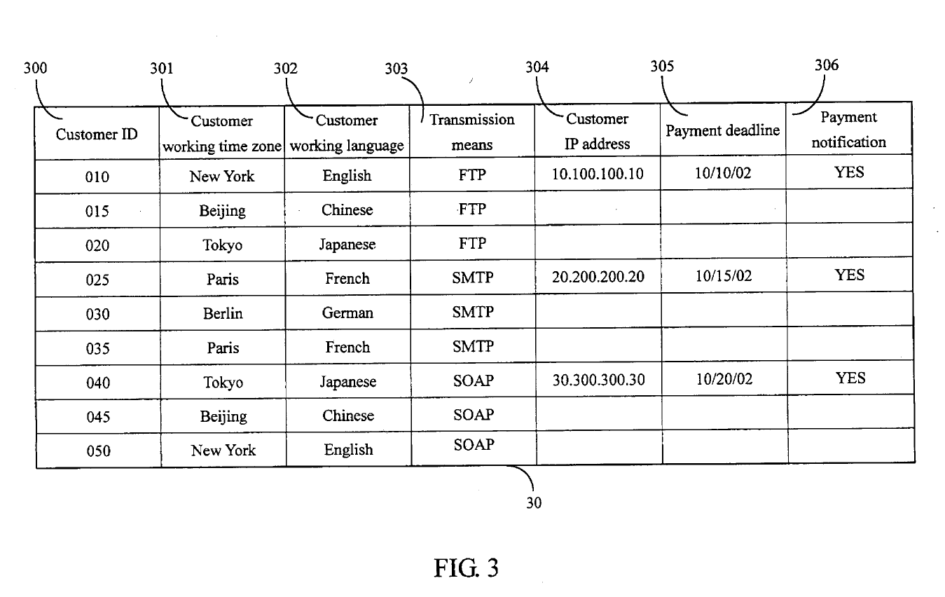

FIG. 3 illustrates an exemplary customer information table 30 according to the present invention. The customer information table 30 is stored in the database server 1, and includes information needed for transmission of payment notifications to respective customers. The customer information table 30 comprises the following fields: customer ID 300, customer working time zone 301, customer working language 302, transmission means 303, customer IP address 304, payment deadline 305, and payment notification 306. Customer ID 300 is used to record an identification number of each customer. Customer working time zone 301 is used to record a time zone of each customer's relevant premises. Customer working language 302 is used to record a preferred language that each customer uses. Transmission means 303 is used to record the preferred transmission means that each customer's communications system supports. Customer IP address 304 is used to record each customer's IP address. Payment deadline 305 is used to record a deadline by which each customer should pay. Payment notification 306 is used to record whether payment notification has been transmitted to each customer.

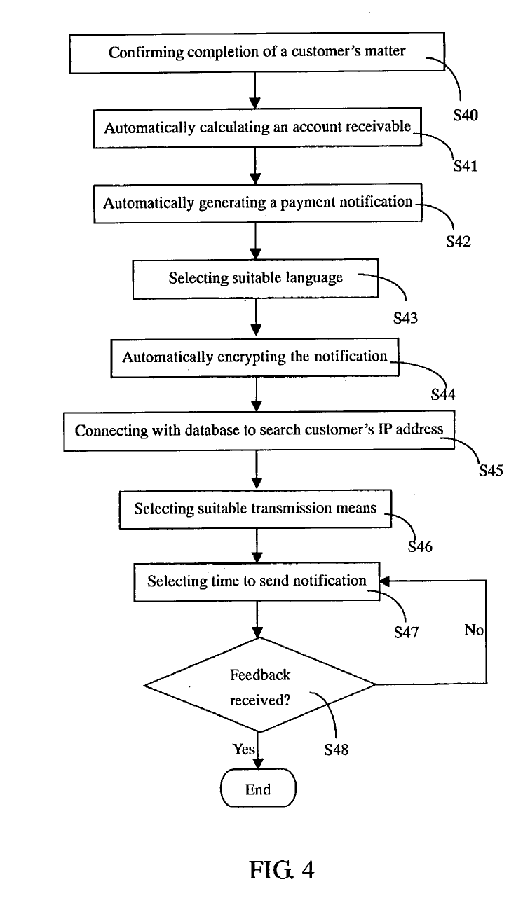

FIG. 4 is a flow chart of a preferred method for generating a payment notification and automatically notifying payment, in accordance with the present invention. The method is implemented in the above-described system for automatically notifying payment. In step S40, the system confirms completion of a customer's matter. In step S41, the application server 2 automatically calculates an account receivable according to the preset formulas and the customer information table 30 stored in the database server 1. In step S42, the application server 2 automatically generates a payment notification, and at the same time records “yes” in payment notification 306 of the customer information table 30. In step S43, the application server 2 selects a suitable language, and translates the payment notification. In step S44, the application server 2 automatically encrypts the notification. In step S45, the application server 2 connects with the database server 1 to search for the customer's IP address. In step S46, the application server 2 selects a suitable transmission means to transmit the payment notification. In step S47, the application server 2 selects the customer's working time zone, to send the payment notification within business hours in said time zone. In step S48, the application server 2 ascertains whether it has received the customer's feedback indicating confirmation of receipt of the payment notification. If the feedback has not been received, the procedure returns to step S47 for retransmission of the payment notification. If and when the feedback has been received, the procedure is ended.

In general, the system and method of the present invention for automatically notifying payment may take forms other than what is described above. While preferred embodiments for carrying out the invention have been described in detail, those familiar with the art to which the invention relates will recognize various alternative designs and embodiments for practicing the invention. These alternative embodiments are also within the scope of the present invention. The scope of the present invention is defined by the claims appended hereto and allowable equivalents thereof.

What is claimed is:

1. A system for automatically notifying payment, the system comprising:
a database server for storing information on customers;
an application server for generating payment notifications and sending the payment notifications to relevant customers according to the information on customers, the application server comprising:
a notification generating module for automatically calculating accounts receivable according to preset formulas and the information on customers, and for generating payment notifications;
a language selection module for automatically selecting suitable languages according to the information on customers, and for translating the payment notifications generated by the notification generating module;
a transmission means selection module for automatically selecting suitable transmission means according to the information on customers, and for transmitting the payment notifications;
a notification encrypting module for automatically encrypting the payment notifications; and
an Internet protocol (IP) address searching module for connecting with the database server to search customers' IP addresses; and
a plurality of client computers for receiving respective payment notifications sent by the application server.

2. The system for automatically notifying payment as described in claim 1, wherein the database server comprises a customer information table that provides information on each of the customers.

3. A method for automatically notifying payment, the method comprising the following steps:
(a) retrieving an account receivable according to preset formulas and customer information stored in a database server;
(b) automatically generating a payment notification, and storing a copy of the payment notification in the database server;
(c) selecting a language according to the customer information, translating the payment notification, and automatically encrypting the payment notification;
(d) selecting a transmission means according to the customer information, and transmitting the encrypted payment notification; and
(e) retransmitting the encrypted payment notification if no customer feedback on the payment notification is received.

4. The method for automatically notifying payment as described in claim 3, wherein the step (a) comprises the step of confirming completion of a customer's matter.

5. The method for automatically notifying payment as described in claim 3, wherein step (d) comprises the step of connecting with the database server to search an Internet protocol (IP) address of the customer.

6. The method for automatically notifying payment as described in claim 3, wherein step (d) comprises the step of automatically selecting a suitable time to send the payment notification according to the customer information.

7. A method of automatically notifying payment, comprising steps of:
(a) retrieving an account receivable according to preset formulas and customer information stored in a database;
(b) automatically generating a payment notification;
(c) selecting a language according to the customer information;
(d) translating the payment notification;
(e) encrypting the payment notification;
(f) obtaining an Internet protocol (IP) address of the customer according to the customer information; and
(g) transmitting the encrypted payment notification to said IP address.
